(19) United States
(12) Patent Application Publication
(10) Pub. No.: US 2011/0141390 A1
(43) Pub. Date: Jun. 16, 2011

(54) CASE FOR PORTABLE ELECTRONIC DEVICE

(75) Inventors: Yu-Sheop LEE, Suwon-si (KR); Sung-Soo Park, Suwon-si (KR)

(73) Assignee: Samsung Electronics Co., Ltd., Suwon-si (KR)

(21) Appl. No.: 12/967,559

(22) Filed: Dec. 14, 2010

(30) Foreign Application Priority Data
Dec. 14, 2009 (KR) 10-2009-0123820

(51) Int. Cl. G02F 1/1333

(52) U.S. Cl. 349/58

(57) ABSTRACT

A case for a portable electronic device includes an outer cover; a frame attached to an inner surface of the outer cover; a color converting liquid crystal display unit interposed between the outer cover and the frame; and an illumination unit interposed between the color converting liquid crystal display unit and the outer cover. The outer cover is made of a translucent or transparent synthetic resin. The color of the case seen from the outside can be changed by varying the color of the color converting liquid crystal display unit and the appearance or color of the portable electronic device can be expressed by controlling the illumination unit even in an environment in which intensity of illumination is weak, making it possible to provide various aesthetic effects to users.

### PRIORITY

This application claims priority under 35 U.S.C. §119(a) to an application entitled “Case For Portable Electronic Device” filed in the Korean Industrial Property Office on Dec. 14, 2009 and assigned Serial No. 10-2009-0123820, the contents of which are incorporated herein by reference.

### BACKGROUND OF THE INVENTION

1. Field of the Invention

The present invention relates generally to a case for various electronic devices manufactured by injection molding, and more particularly, to a case for portable electronic devices such as portable game devices carried by users, multimedia reproducers having music or video reproducing functions, electronic notebooks, and mobile communication terminals.

2. Description of the Related Art

In general, portable electronic devices refer to devices such as portable game devices, multimedia reproducers, and mobile communication terminals, which provide functions such as gaming, reproduction of multimedia, and communications while users are carrying them. Due to recent advances in electronic technologies, various functions can be realized using a single device.

An example of a portable electronic device is a mobile communication terminal. While mobile communication terminals only had functions of voice communication or short message service at the initial stage, they recently have incorporated various functions such as gaming, reproduction of music or videos, digital multimedia broadcasting, and provision of wireless internet. As mobile communication services are activated and mobile communication terminals are used, users carry mobile communication terminals rather than carrying several devices having different functions to enjoy various functions with the single device.

Portable electronic devices are not only used with their own functions but also as decorations for expressing the personalities of users by decorating them using hand straps, protective cases, stickers, etc. This is because portable electronic devices themselves have a limit in expressing the personalities of users. Meanwhile, in spite of the fact that manufacturers intend to satisfy the demands of users by manufacturing devices having various shapes, there are limitations in satisfying these demands.

Accordingly, manufacturers are trying to provide visual effects to cases for portable electronic devices. For example, visual effects for realizing various designs may be provided using a plurality of light emitting diodes disposed on inner surfaces of cases during voice communications or reception of short messages. Devices for changing surrounding illuminations or the colors of cases using color converting liquid crystal display units have been suggested.

FIGS. 1 and 2 illustrate an existing case 10 for a portable electronic device.

As illustrated, the case 10 has a structure in which a frame 17 is attached to an inner surface of an outer cover 19 and a color converting liquid crystal display unit 11 is installed between an inner surface of the outer cover 19 and the frame 17. In this case, the outer cover 19 is made of a semitransparent or transparent synthetic resin such that colors realized in the color converting liquid crystal display unit 11 or the frame 17 can be seen from the outside. Meanwhile, a drive circuit 15 is installed in the frame 17 and a flexible printed circuit 13 extending from the color converting liquid crystal display unit 11 is connected to the drive circuit 15.

In the color converting liquid crystal display unit 11, a liquid crystal layer 25 is formed between substrates 21 and 23 and a back paint layer 27 formed by ejecting or depositing paint is provided at the bottom surface thereof. The color converting liquid crystal display unit 11 is configured to show the color realized in the liquid crystal layer 25 to the outside by using the back paint layer 27 that reflects the light from the outside without using a separate illumination unit, and such devices are disclosed in Korean Patent No. 639,046, Korean Laid-Open Patent No. 2000-2828, U.S. Pat. No. 5,570,216, U.S. Pat. No. 6,061,107, and the like.

However, even when the color converting liquid crystal display unit is installed, the color converting liquid crystal display unit that realizes colors using the light from the outside cannot sufficiently show the color of the case at night or in a room of weak illumination. Moreover, it becomes difficult to vary the color of the case only to realize the natural color of the color converting liquid crystal display unit, which only increases manufacturing costs. As a result, cases and portable electronic devices having them cannot be effectively varied, considering manufacturing costs for installing color converting liquid crystal display units.

### SUMMARY OF THE INVENTION

Accordingly, the present invention has been made to solve the above-mentioned problems occurring in the prior art. The present invention provides a case for a portable electronic device that realizes a variety of colors in a low-illumination environment.

The present invention also provides a case for a portable electronic device that realizes various colors and patterns in the appearance of the device, thereby showing various visual effects.

The present invention further provides a case for a portable electronic device that realizes different visual effects according to the operation of the device.

In accordance with an aspect of the present invention, there is provided a case for a portable electronic device including an outer cover; a frame attached to an inner surface of the outer cover; a color converting liquid crystal display unit interposed between the outer cover and the frame; and an illumination unit interposed between the color converting liquid crystal display unit and the outer cover, wherein the outer cover is made of a translucent or transparent synthetic resin.

In this case, the illumination unit may includes a light guide plate facing the color converting liquid crystal display unit; a light source installed at one end portion of the light guide plate; and a flexible printed circuit connected to the light source.

A back paint layer may be formed between the color converting liquid crystal display unit and the frame to express various colors using the color realized through the color converting liquid crystal display unit and the color of the back paint layer.

The case may further include a window film interposed between the outer cover and the illumination unit. By forming a pattern in the window film using a symbol of a manufacturer, a symbol of a telecom company, a hologram, etc., not only a simple change in color but also various types of decoration effects can be provided.

According to the case for a portable electronic device of the present invention, the color seen from the outside of the case can be actively changed by using the color converting liquid crystal display unit, allowing the various colors of the electronic device to be expressed. Furthermore, an aesthetic effect can be provided to a user by realizing various visual effects with the illumination unit and the appearance and color of the terminal can be shown in an environment of a low intensity of illumination by using the illumination unit.

### BRIEF DESCRIPTION OF THE DRAWINGS

The above and other aspects, features and advantages of the present invention will be more apparent from the following detailed description taken in conjunction with the accompanying drawings, in which:

FIG. 1 is an exploded perspective view illustrating an existing case for a portable electronic device;

FIG. 2 is a sectional view illustrating a color converting liquid crystal display unit of the case shown in FIG. 1;

FIG. 3 is an exploded perspective view illustrating a case for a portable electronic device according to an embodiment of the present invention;

FIG. 4 is a view illustrating a window film of the case shown in FIG. 3; and

FIG. 5 is a view illustrating another type of window film of the case shown in FIG. 3.

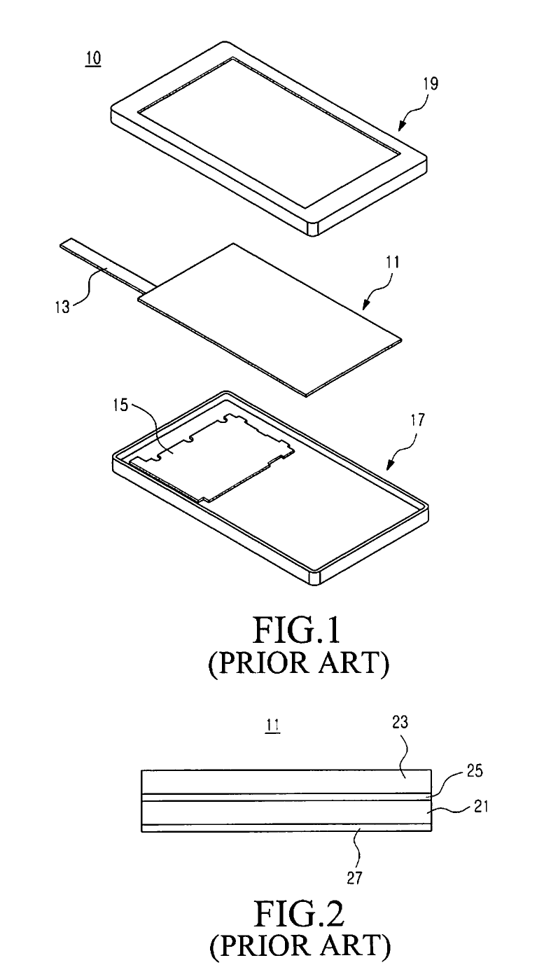

### DETAILED DESCRIPTION OF EMBODIMENTS OF THE PRESENT INVENTION

Hereinafter, embodiments of the present invention will be described with reference to the accompanying drawings. In the following description of the present invention, a detailed description of known functions and configurations incorporated herein will be omitted when it may make the subject matter of the present invention unclear.

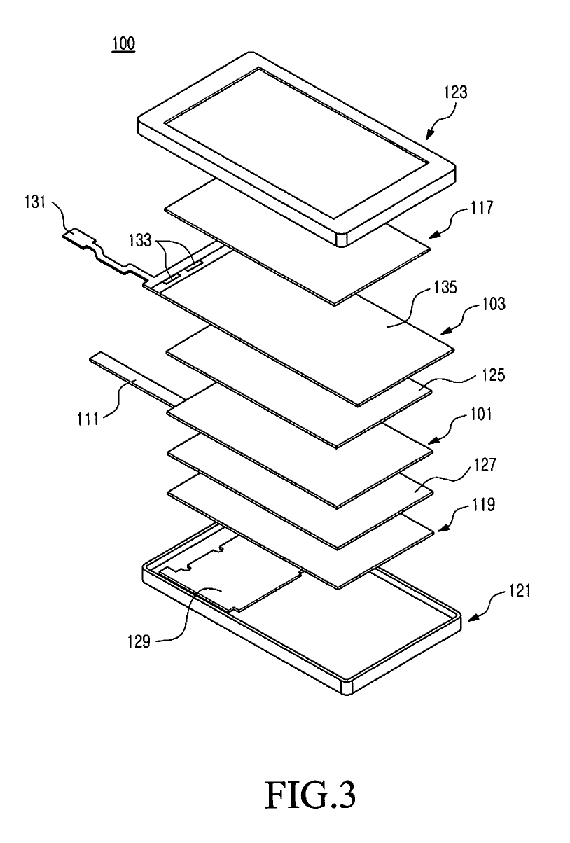

FIG. 3 is an exploded perspective view illustrating a case 100 for a portable electronic device according to an embodiment of the present invention which may be used in various devices such as a mobile communication terminal, a portable game device, an electronic notebook, and a portable multimedia reproducer. It is apparent that although the structure of the case 100 is simplified to have a rectangular flat plate shape in the description of the embodiment of the present invention, the shape of the case may be modified according to a product to which the case is actually applied.

As illustrated in FIG. 3, the case 100 for a portable electronic device includes an outer cover 123 made of a translucent or transparent synthetic resin, a frame 121 attached to an inner surface of the outer cover 123, a color converting liquid crystal display unit 101 interposed between the frame 121 and the outer cover 123, and an illumination unit 103 interposed between the color converting liquid crystal display unit 101 and the outer cover 103. The color converting liquid crystal display unit 101 does not use a separate light source but reflects external light using a back paint layer 119 to allow the color realized in the liquid crystal layer to be seen from the outside. The illumination unit 103 may be located outside the color converting liquid crystal display unit 101 to project light to the color converting liquid crystal display unit 101.

The outer cover 123 is positioned at the outermost side of the case 100 and is made of a translucent or transparent material to allow a color or pattern within it to be seen from the outside. The entire outer cover 123 may not be made of a translucent or transparent material. An opening and a window may be installed if the outer cover 123 itself is not transparent in the same way as a general electronic device having an opening and a transparent window, which allows its display unit to be seen from the outside.

The frame 121 is adapted to fix the color converting liquid crystal display unit 101, the illumination unit 103, etc. to an inner surface of the outer cover 123. A recess of a predetermined depth is formed on a surface of the frame 121 facing an inner surface of the outer cover 123 and a drive circuit board 129 is attached to the inside of the recess. A circuit for controlling and driving the color converting liquid crystal display unit 101 and the illumination unit 103 is mounted to the drive circuit board 129.

The color converting liquid crystal display unit 101 is adapted to receive external light and reflect some of the light to the outside to expose the color realized in a liquid crystal layer provided between the substrates to the outside, and a reflective layer is preferably between the color converting liquid crystal display unit 101 and the frame 121. An example of the color converting liquid crystal display unit may be a Cholesteric Liquid Crystal Display (LCD) having a thickness of 0.1 to 0.3 mm. In the embodiment of the present invention, a reflective layer is formed by providing the back paint layer 119 between the frame 121 and the color converting liquid crystal display unit 101. The back paint layer 119 may be printed on a thin film using silk screening or digital printing, and the thin film is attached to the color converting liquid crystal display unit 101 by means of an optical adhesive 127. The back paint layer 119 may have a thickness of 0.1 to 0.3 mm. The color converting liquid crystal display unit 101 includes a flexible printed circuit 111 connected to the drive circuit board 129.

The color converting liquid crystal display unit 101 realizes a certain color through a liquid crystal layer according to a control signal provided from the drive circuit board 129, and the color of the back paint layer 119 and the color realized by the color converting liquid crystal display unit 101 are combined to be exposed to the outside. Thus, the color of the case 100 exposed to the outside is also changed when the color realized through the color converting liquid crystal display unit 101 is changed.

Meanwhile, the color of the back paint layer 119 may be selected in a variety ways, and since the color of the case 100 can be changed through the color converting liquid crystal display unit 101, the color of the back paint layer 119 may be selected preferably from black, gray, or white. The back paint layer 119 may have a single color, but may have a gradation effect in which black is gradually changing to white, black to gray, or gray to white, or may have a visual effect by forming various patterns such as a water drop pattern or a check pattern in the back paint layer 119.

The illumination unit 103 is provided between the outer cover 123 and the color converting liquid crystal unit 101 such that light enters the color converting liquid crystal display unit 101, and is reflected by the back paint layer 119 to pass through the color converting liquid crystal display unit 101 again. Accordingly, the case 100 can express its appearance or color to the outside in a room of weak illumination or outside of a room at night.

The illumination unit 103 is connected to the drive circuit board 129 through another flexible printed circuit 131 and includes a plurality of light sources 133 such as light emitting diodes. The light sources 133 emit light using the power and control signals provided by the drive circuit board 129. The light produced by the light sources 133 may directly enter the color converting liquid crystal display unit 101, but the illumination unit 103 includes a light guide plate 135 having a thickness of 0.1 to 0.2 mm to uniformly illuminate the entire area of the color converting liquid crystal display unit 101. That is, the light generated by the light sources 133 is diffused to the entire area of the color converting liquid crystal display unit 101 through the light guide plate 135.

A diffused reflection pattern is formed preferably on at least one surface of the light guide plate 135 such that the light diffused to the light guide plate 135 is scattered. At least some of the light dispersed by the diffused reflection pattern enters the color converting liquid crystal display unit 101. The light entering the color converting liquid crystal display unit 101 is reflected on the back paint layer 119 to pass through the color converting liquid crystal display unit 101.

Meanwhile, the illumination unit 103 is accommodated in the frame 121 and the frame 121 preferably prevents the light generated by the light sources 133 from being leaked through a path other than the light guide plate 135 to allow the light generated by the light sources 133 to be used only for illumination of the color converting liquid crystal display unit 101.

In installing the illumination unit 103, the light guide plate 135 is preferably attached to the color converting liquid crystal display unit 101 using an optical adhesive 125. By attaching the back paint layer 119 and the light guide plate 135 to the color converting liquid crystal display unit 101 using an optical adhesive, bubbles or foreign substances are prevented from being generated or interposed between the back paint layer 119 and the color converting liquid crystal display unit 101 or between the color converting liquid crystal display unit 101 and the light guide plate 135, making it impossible for light to be refracted or distorted while the light is proceeding.

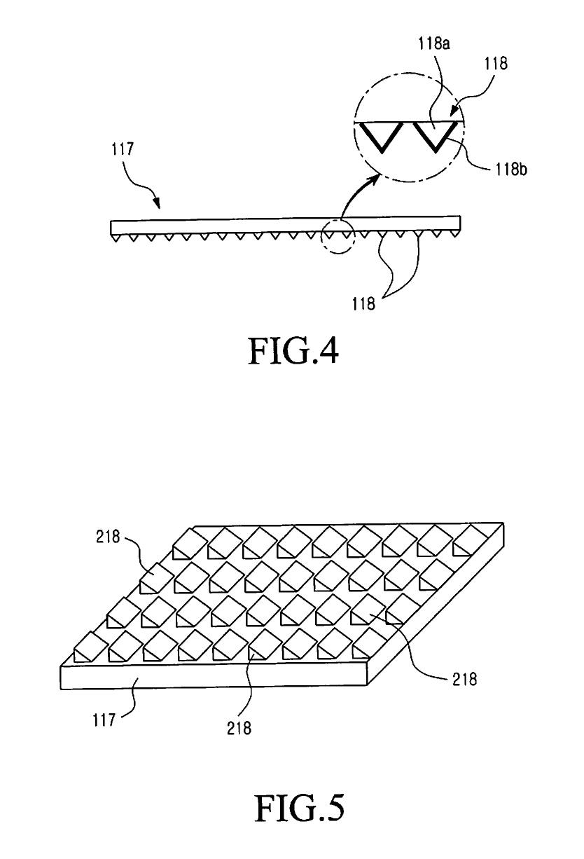

A window film 117 may be interposed between the outer cover 123 and the light guide plate 135. The window film 17 may not necessarily be installed, but may be useful in providing various patterns of different shapes such as a logo of a manufacturer of a product to which the case 100 is applied, a logo of a telecom company, or a brand symbol of a product. FIGS. 4 and 5 illustrate examples of forming patterns using the window film 117. In FIG. 4, a pattern 118 is formed on an inner surface of the window film 117 facing the light guide plate 135 using fine patterns. The pattern 118 formed on an inner surface of the window film 117 is preferably a pattern which is formed by UV molding, that is, which is hardened using ultraviolet hardening ink, and a reflective coating layer 118b may be formed on the pattern 118a if necessary. The pattern 118a itself can realize a logo of a manufacturer or a telecom company, a brand symbol of a product, or a geometric decoration and even can create a hologram effect by forming the reflective coating layer 118b as a mirror surface on the pattern 118a. As illustrated in FIG. 5, a decoration effect using regular patterns or wave patterns can be realized using protrusions 218 formed on the inner surface of the window film 117.

The case 100 can express various colors by combining the color of the back paint layer 119 and the color realized through the color converting liquid crystal display unit 101 in an environment in which intensity of illumination is sufficient enough not to use a separate illumination unit. Further, the color of the case 100 can be expressed to the outside by driving the illumination unit 103 to provide illumination in an environment in which intensity of illumination is weak. Furthermore, since the illumination unit 103 itself can vary the color of the case 100 in a variety of forms, a visual effect of various patterns can be realized by changing the color of the case 100 according to the operation of the portable electronic device having the case 100.

While the invention has been shown and described with reference to certain embodiments thereof, it will be understood by those skilled in the art that various changes in form and details may be made therein without departing from the spirit and scope of the invention as defined by the appended claims.

What is claimed is:

1. A case for a portable electronic device, comprising:
an outer cover;
a frame attached to an inner surface of the outer cover;
a color converting liquid crystal display unit interposed between the outer cover and the frame; and
an illumination unit interposed between the color converting liquid crystal display unit and the outer cover,
wherein the outer cover is made of a translucent or transparent synthetic resin.

2. The case for a portable electronic device of claim 1, wherein the illumination unit comprises:
a light guide plate facing the color converting liquid crystal display unit;
a light source installed at one end portion of the light guide plate; and
a flexible printed circuit connected to the light source.

3. The case for a portable electronic device of claim 2, wherein a diffused reflection pattern is formed on at least one surface of the light guide plate to scatter light generated by the light source and diffused through the light guide plate.

4. The case for a portable electronic device of claim 1, further comprising a back paint layer interposed between the color converting liquid crystal display unit and the frame.

5. The case for a portable electronic device of claim 4, wherein the back paint layer reflects the light entering through the color converting liquid crystal display unit, so as to make the light proceed back through the color converting liquid crystal display unit.

6. The case for a portable electronic device of claim 4, wherein the back paint layer is printed on a thin film by silk screening or digital printing.

7. The case for a portable electronic device of claim 6, wherein the back paint layer is printed in black, gray, or white.

8. The case for a portable electronic device of claim 6, wherein a color of the back paint layer is gradually varied as it goes from one point to another point on the thin film.

9. The case for a portable electronic device of claim 6, wherein the back paint layer includes a decoration pattern.

10. The case for a portable electronic device of claim 6, wherein the thin film is attached to the color converting liquid crystal display unit by an optical adhesive.

11. The case for a portable electronic device of claim 1, further comprising a window film interposed between the case and the illumination unit.

12. The case for a portable electronic device of claim 11, wherein the window film includes a decoration pattern on a surface thereof facing the illumination unit.

13. The case for a portable electronic device of claim 12, wherein a reflective layer is formed in the decoration pattern.

14. The case for a portable electronic device of claim 1, wherein the illumination unit includes a light guide plate facing the color converting liquid crystal display unit and the light guide plate is attached to the color liquid crystal display unit by an optical adhesive.
